(19) United States
(12) Patent Application Publication
(10) Pub. No.: US 2018/0265196 A1
(43) Pub. Date: Sep. 20, 2018

(54) Quick-Deploying Portable Unmanned Aerial System (UAS)/ Unmanned Aerial Vehicle (UAV) Landing Pad

(71) Applicants: Frank Andrew Phillips, Marietta, GA (US); Al Eckford, Marietta, GA (US)

(72) Inventors: Frank Andrew Phillips, Marietta, GA (US); Al Eckford, Marietta, GA (US)

(21) Appl. No.: 15/925,460

(22) Filed: Mar. 19, 2018

Related U.S. Application Data
(60) Provisional application No. 62/473,052, filed on Mar. 17, 2017.

(51) Int. Cl. B64C 39/02; B64F 1/00; B64F 1/20

(52) U.S. Cl. CPC B64C 39/024; B64F 1/007; B64C 2201/18; B64C 2201/024; B64F 1/20

(57) ABSTRACT

A quick-deploying portable unmanned aerial system/unmanned aerial vehicle (UAV) pad that provides a landing zone in a variety of different environments. The pad includes a flexible basal platform, a flexible band, a plurality of electronic accessories, and an operations management hub. The flexible basal platform outlines a landing zone and is composed of a non-permeable fabric. The flexible band is concentrically aligned with a central axis of the flexible basal platform and is tensionably mounted to the flexible basal platform. The plurality of electronic accessories includes a plurality of light-emitting diodes (LEDs) and a wireless communication device for facilitating landing procedures. The plurality of LEDs is distributed and adjacently connected about the flexible basal platform for increased visibility. The wireless communication device allows for wireless connection with a user and or a UAV. The operations management hub electrically and electronically controls the electronic accessories.

The current application claims a priority to the U.S. Provisional Patent application Ser. No. 62/473,052 filed on Mar. 17, 2017.

### FIELD OF THE INVENTION

The present invention relates generally to a landing pad for an unmanned aerial vehicle with potential articulating elements for a plurality of environments and environmental conditions with potential smartphone interfacing.

### BACKGROUND OF THE INVENTION

Drone and unmanned aerial vehicle, or UAV, usage is on the rise both between hobbyists, enthusiasts, and professional businesses and organizations alike. And although a UAV does possess the ability to land independent of a platform, such landings can be tricky at their best in the dark, and costly at their worst during dark or damp conditions. A dedicated landing pad would solve much of this and permit UAV operation after sunset and low light intensity situations through both luminosity driven light emitting diode (LED) homing systems and thermal based infrared homing systems. With the possible advent of drone delivery in the future, a means of hailing such a UAV operation would be proactive to meet the demand of such a practice where the present apparatus would allow for the user's landing pad to be serialized and linked specifically to them to differentiate a designated drop point through a discrete beacon broadcaster. The apparatus would further facilitate this practice by providing a means to sync operation, control and authorization through a user's smart phone to control the infrared and LED based homing systems. The apparatus would further provide a means of mitigating debris and dust kick up caused through landing and takeoff that can damage the UAV itself through a plurality of dust suppression skirts

### BRIEF DESCRIPTION OF THE DRAWINGS

FIG. 1 is a perspective view of the present invention.

FIG. 2 is a perspective view of an alternative embodiment of the present invention.

FIG. 3 is a detailed cross-section of the present invention depicting the flexible band, the fastening mechanism, and the weight bag.

FIG. 4 is an electric diagram of the present invention.

FIG. 5 is an electronic diagram of the present invention.

### DETAIL DESCRIPTIONS OF THE INVENTION

All illustrations of the drawings are for the purpose of describing selected versions of the present invention and are not intended to limit the scope of the present invention.

The present invention relates generally to unmanned aerial vehicles (UAVs) accessories. More specifically, the present invention is a drone landing platform designed to facilitate precise and safe landing of UAVs in a variety of environments.

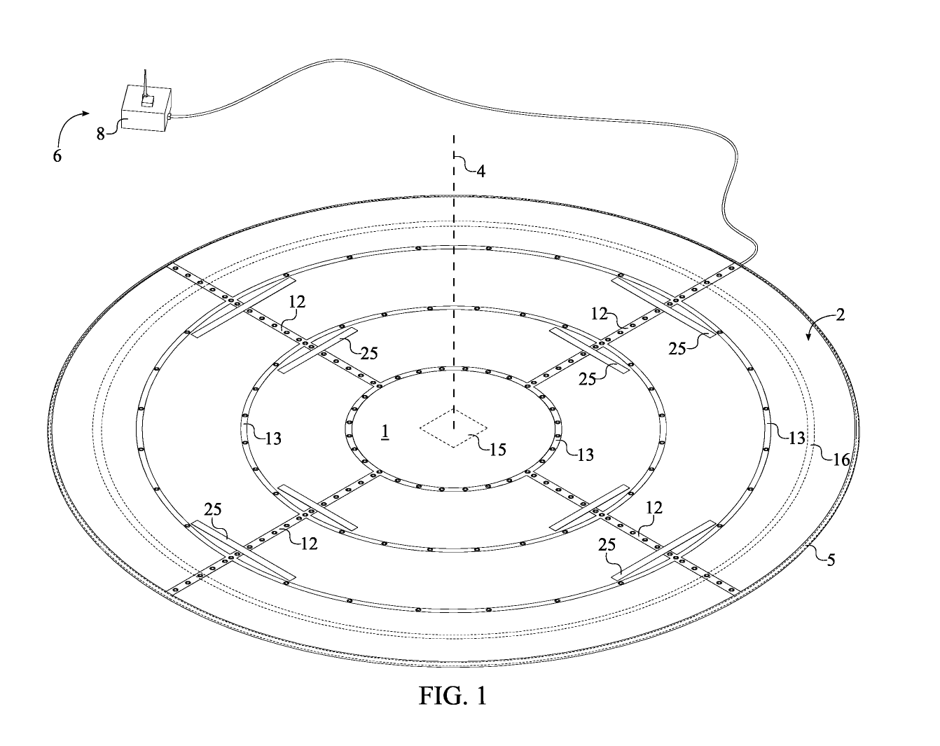

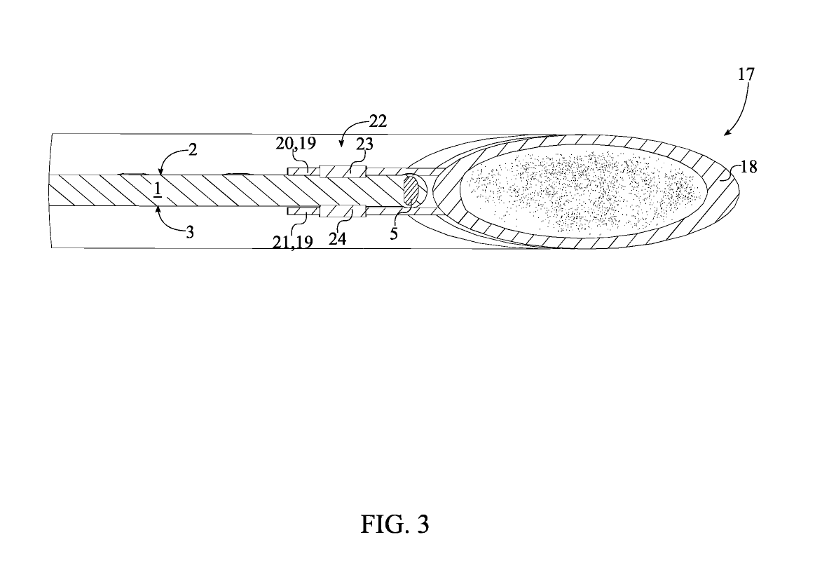

Referring to FIG. 1 and FIG. 3, in the simplest embodiment, the present invention comprises a flexible basal platform 1 and a flexible band 5. The flexible basal platform 1 is a circular-shaped planar base which acts as a receptive surface for a UAV to land on; although, alternative geometries may also be utilized. The preferred flexible basal platform 1 is composed of non-permeable fabric such that the present invention may be positioned into a collapsed configuration for storage and transportation purposes. Additionally, the flexible basal platform 1 is preferably curvilinear in shape, forming the majority of the planar area of the apparatus. The flexible basal platform 1 may additionally be comprised of a more rectilinear, triangular, or other such polygonal shapes that assume a degree of symmetric geometry. The flexible basal platform 1 is intended to lie flush on the ground atop grass, dirt, sand, concrete, asphalt and so on to provide a landing location for a UAV. The flexible basal platform 1 would further allow for the interstitial cavity space to accommodate a lighting and wiring system and further allow for the apparatus to collapse into a smaller curvilinear shape for storage. The flexible basal platform 1 would further still provide for a waterproofing means that would allow for the apparatus to be laid on damp fields without damage to the wiring, lighting, and possible processing means disposed therein. The material choice of the flexible basal platform 1 is preferably that of a waterproof cloth, however, other materials may be used including but not limited to: rubber, plastics, light flexible synthetic or organic materials, and so on.

Referring to FIG. 1, the flexible band 5 outlines the perimeter of the flexible basal platform 1 and keeps the flexible basal platform 1 in a taught state when the present invention is in an open configuration. In particular, the flexible band 5 is an annular ring with a very small diametric which provides the flexible basal platform 1 a degree of spring compression to allow the present invention to be positioned into the open configuration and a collapsed configuration. More specifically, the flexible band 5 is concentrically aligned with a central axis 4 of the flexible basal platform 1 to provide symmetric support. Additionally, the flexible band 5 is perimetrically and laterally positioned about the flexible basal platform 1. For this, the flexible band 5 is sized and shaped to compliment the outer edge/perimeter of the flexible basal platform 1. To keep the flexible basal platform 1 in a planar and taught state, the flexible band 5 is tensionably mounted to the flexible basal platform 1. In the open configuration, the flexible band 5 circumnavigates the central axis 4 a single time. In the open configuration the present invention forms a landing platform for a UAV. In the collapsed configuration, the flexible band 5 is twisted at two radially opposing points in order to twist the flexible band 5 about the central axis 4 a multitude of times, thus collapsing the flexible basal platform 1 onto itself. Resultantly, the overall profile of the present invention is reduced significantly; the tension in the flexible band 5 keeps the present invention in this configuration until the user applies an external twisting force.

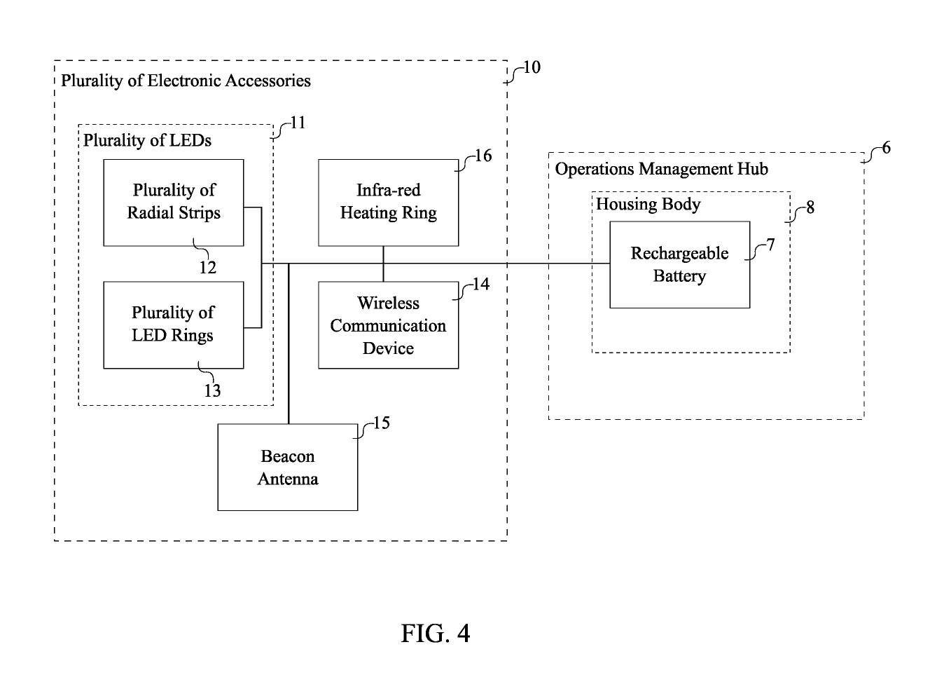

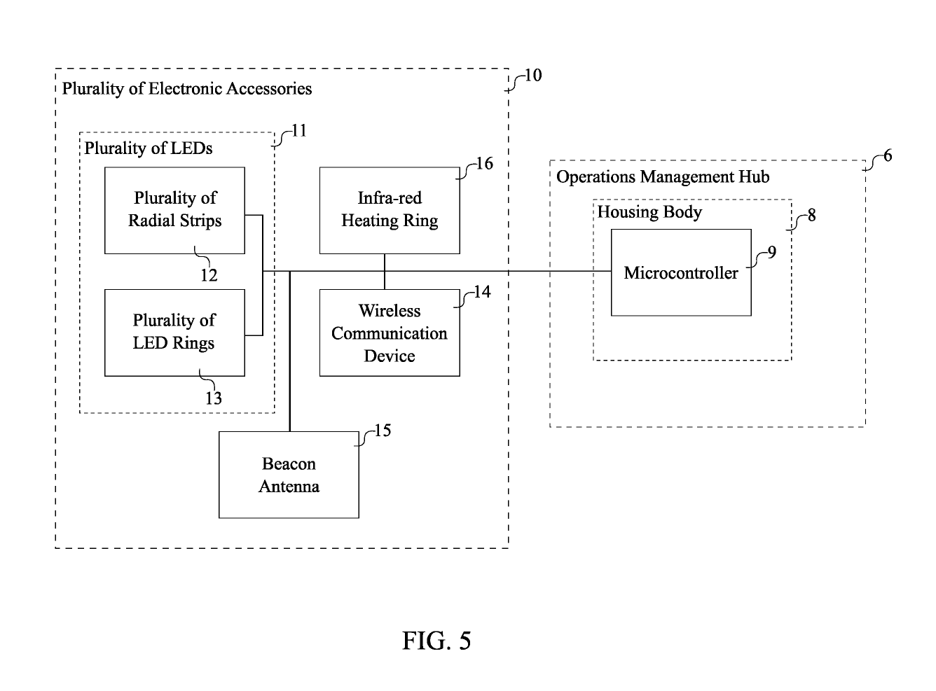

Referring to FIG. 4 and FIG. 5, the present invention may further comprise a plurality of electronic accessories 10, an operations management hub 6, a plurality of high-visibility strips 25, and an at least one weight bag 17. The plurality of electronic accessories 10 provides a UAV with visual and electronic signals for landing operations. In general, the plurality of electronic accessories 10 is operatively integrated into the flexible basal platform 1 and is powered and controller by the operations management hub 6. More specifically, the plurality of electronic accessories 10 comprises a plurality of light-emitting diodes (LEDs) 11, a wireless communication device 14, a beacon antenna 15, and an at least one infra-red heating ring 16. Additionally, the operations management hub 6 comprises a rechargeable battery 7, a housing body 8, and a microcontroller 9. The rechargeable battery 7 provides the necessary electric supply to power the plurality of electronic accessories 10. The microcontroller 9 directly or indirectly controls the function of each of the plurality of electronic accessories 10. The housing body 8 contains and protects the microcontroller 9 and the rechargeable battery 7. The housing body 8 is a box-like structure that is laterally tethered to the flexible basal platform 1. Additionally, the rechargeable battery 7 and the microcontroller 9 are mounted within the housing body 8 so as to be positioned offset from the flexible basal platform 1 and not interfere with landing procedures of a UAV.

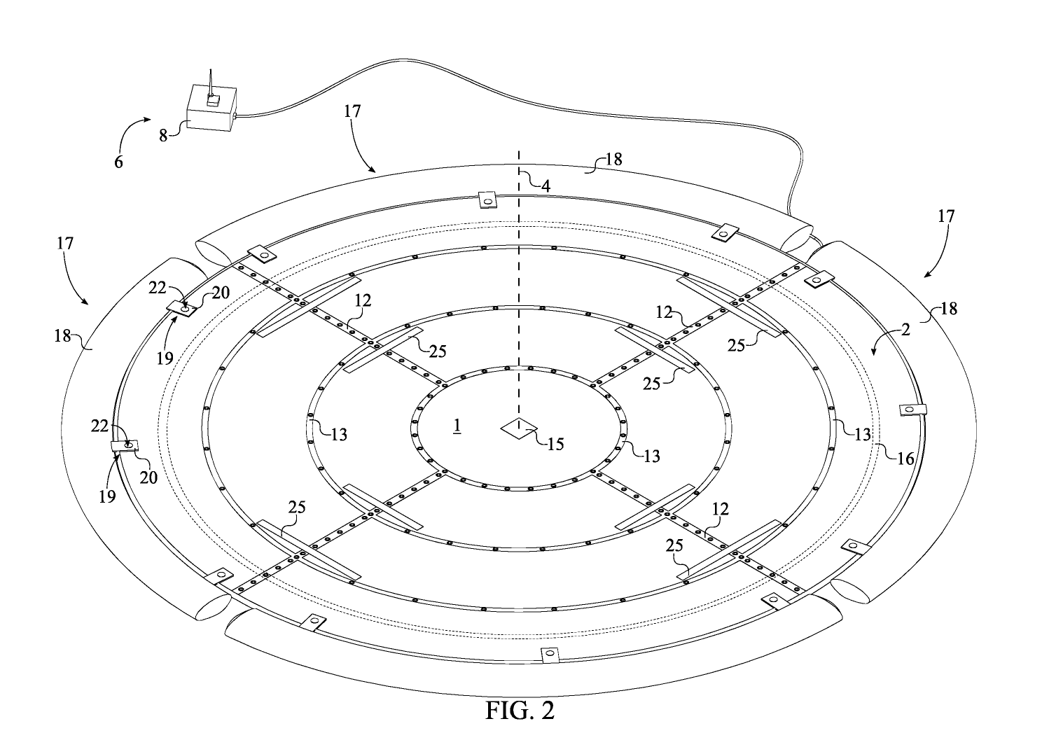

The plurality of LEDs 11 provides a visual landing target for a UAV. Referring to FIG. 1 and FIG. 2, the plurality of LEDs 11 is distributed about the flexible basal platform 1. The pattern with which the plurality of LEDs 11 is distributed about the flexible basal platform 1 is subject to change to meet the needs and preferences of environment conditions, visual tracking programs, different users, and different applications. Each of the plurality of LEDs 11 is integrated into the flexible basal platform 1, adjacent to a top surface 2 of the flexible basal platform 1 for increased exposure and visibility. In the preferred embodiment of the present invention, the plurality of LEDs 11 comprises a set of radial LED strips 12 and a set of LED rings 13. The set of radial LED strips 12 delineate a crosshair target for a UAV to recognize or utilize in landing procedures. Each of the set of radial LED strips 12 is a series of two-lead semiconductor light sources configured in a straight and linear fashion. The set of radial LED strips 12 is radially distributed about the central axis 4 to divide the flexible basal platform 1 into equal sectors. It is preferred there are four strips within the set of radial LED strips 12 which radially extend outwards from the central axis 4; thus, dividing the flexible basal platform 1 into four quadrants. However, additional or fewer sets may be used. Furthermore, denser or sparser proximity between each of the set of radial LED strips 12 may be implemented depending on the needs and preferences of the user.

The set of LED rings 13 delineate a circular target for a UAV to recognize or utilize in landing procedures. Each within the set of LED rings 13 is a series of two-lead semiconductor light sources configured into a circular pattern. The set of LED rings 13 is preferably configured in a bullseye pattern. In particular, each within the set of LED rings 13 is concentrically positioned with each other. Additionally, the set of LED rings 13 is radially distributed from the central axis 4 of the flexible basal platform 1 to form concentric circles for high visibility borders. The preferred number within the set of LED rings 13 is three; although, the set of LED rings 13 may include more or less.

Referring to FIG. 1, each of the plurality of high-visibility strips 25 is generally rectilinear in shape and is composed of reflective material for increased visibility to provide an amplified and more illuminative target for a UAV to utilize during landing procedures. Alternative shapes, geometry, and composition may also be utilized for each of the plurality of high-visibility strips 25. The plurality of high-visibility strips 25 is radially distributed about the central axis 4 of the flexible basal platform 1. Additionally, each of the plurality of high-visibility strips 25 is adjacently connected to the top surface 2. In alternative embodiments of the present invention, each of the plurality of high-visibility strips 25 may be integrated into the top surface 2 or superimposed over the top surface 2 so as to not produce an obstruction to a UAV. In addition to the plurality of high-visibility strips 25, the present invention may also include a set of cardinal markers, wherein the cardinal markers are radially distributed about the central axis 4 and positioned towards the outer perimeter of the flexible basal platform 1. Located at the center and preferably possessed of a geometry as dictated by the flexible basal platform 1 is the central indicium that provides some means of logo, ownership, or other such means of identity to the present invention.

For extreme weather conditions where visibility is low, and the plurality of LEDs 11 is not enough, the present invention also provides an infra-red signal for a UAV to identify. This is achieved by the infra-red heating ring 16, wherein the infra-red heating ring 16 is an electric heating pad in the form of a ring. The infra-red heating ring 16 is concentrically aligned with the central axis 4 of the flexible basal platform 1 and is integrated into the flexible basal platform 1. The infra-red heating ring 16 produces a noticeable heat marking outlining the perimeter of the flexible basal platform 1 to a UAV possessing a heat sensor to aid in landing operations during low luminosity or night time conditions. In alternative embodiments of the present invention, the at least one infra-red heating ring 16 may comprise a plurality of heating rings to further increase the infra-red signal.

Referring to FIG. 2 and FIG. 3, the at least one weight bag 17 acts as an anchor to secure the flexible basal platform 1 in place such that high winds and other environmental factors do not dislodge or move the present invention. The weight bag 17 comprises a weighted holding pouch 18, and at least one pair of straps 19, and an at least one fastening mechanism 22. The weighted holding pouch 18 is a semi-annular enclosure composed of fabric designed to receive weighted materials, debris, plates, dirt, or other similar heavy items. The weighted holding pouch 18 includes a main opening for the addition and removal of weighted articles; the main opening is preferably closed and opened through a locking mechanism such as a zipper, although alternative mechanisms may also be utilized. The weighted holding pouch 18 is attached to the flexible basal platform 1 by the pair of straps 19 and the fastening mechanism 22. For said attachment, the weighted holding pouch 18 is laterally positioned to the flexible basal platform 1. The pair of straps 19 is laterally connected to the weighted holding pouch 18, adjacent to the flexible basal platform 1. More specifically, a first strap 20 from the pair of straps 19 is positioned adjacent to the top surface 2 of the flexible basal platform 1 and a second strap 21 from the pair of straps 19 is positioned adjacent to a bottom surface 3 of the flexible basal platform 1. Resultantly, the flexible basal platform 1 is sandwiched in between the first strap 20 and the second strap 21. The fastening mechanism 22 secures this configuration; in particular, the fastening mechanism 22 is mechanically integrated into the first strap 20 and the second strap 21. Thus, the first strap 20 and the second strap 21 are attached to each other by the fastening mechanism 22.

A variety of different mechanisms may be used as the fastening mechanism 22 including, but not limited to, clips, buttons, hooks, and hook-and-loop fasteners. It is preferred that the fastening mechanism 22 comprises a first magnetic element 23 and a second magnetic element 24. The first magnetic element 23 is integrated into the first strap 20. Complimentary, the second magnetic element 24 is integrated into the second strap 21. Resultantly, when the first strap 20 is positioned overlapping the second strap 21, the first magnetic element 23 is coupled to the second magnetic element 24 through the flexible basal platform 1, thus attaching the weighted holding pouch 18 to the flexible basal platform 1.

The wireless communication device 14, the beacon antenna 15, and the microcontroller 9 allow for the present invention to connect and engage with a UAV in order to perform a variety of functions including, but not limited to, implementing authorization handshake protocols, guidance, and notification of UAV proximity relative to the present invention to the user. For example, the present invention may be used for UAV-delivery services where the present invention is permanently affixed to the user's abode, able to provide the user a notification or other up-to-date information regarding the location of his or her package. The beacon antenna 15 amplifies the sending and receiving signal of the wireless communication device 14. The beacon antenna 15 is centrally integrated into the flexible basal platform 1 and is electronically connected to the wireless communication device 14. The wireless communication device 14 is externally mounted to the flexible basal platform 1. Preferably, the wireless communication device 14 is mounted within the housing body 8 of the operations management hub 6. The electronic components of the present invention may be powered by a multitude of different means rather than the rechargeable battery 7 including, but not limited to, a power outlet, a battery pack, and a solar panel system. Furthermore, the wireless communication device 14 and the beacon antenna 15 allows the present invention to wireless connect to external computing devices such as a laptop, a smartphone, and other similar devices. This allows a user to wirelessly control and monitor the present invention.

In an alternative embodiment of the present invention, attached at the outer perimeter of the flexible basal platform 1 is a plurality of dust suppression skirts. The plurality of dust suppression skirts is preferably four in count and when fully fanned out, provides a larger diameter of the overall apparatus. The plurality of dust suppression skirts is intended to provide a wider area of protection to mitigate a UAV or drone from kicking up dust and debris that would land atop the flexible basal platform 1 or other elements therein and thereon. Further, the geometry of each of the plurality of dust suppression skirts would preferably be in annular segments where the total count of the plurality of dust suppression skirts produces a near, full annular shape surrounding the flexible basal platform 1. The plurality of dust suppression skirts additionally allows for the folding and securement to the bottom surface 3 of the flexible basal platform 1 when not necessary through a plurality of suppression skirt fasteners. Located at the interstitial space between an arbitrary skirt from the plurality of dust suppression skirts and the outer perimeter of the flexible basal platform 1 is a corresponding suppression skirt fastener from the plurality of dust suppression skirt fasteners that allows the arbitrary skirt to preferably pivot and hinge; wherein the arbitrary skirt is any from the plurality of dust suppression skirts. Although each of the plurality of the suppression skirt fastener may additionally comprise clips, snaps, snap-fits, threaded fasteners and so on to selectively secure the plurality of dust suppression skirts to the flexible basal platform 1. In yet another embodiment of the present invention, the suppression disk may be used instead or in addition to the plurality of dust suppression skirts. The suppression disk is placed directly under the flexible basal platform 1 and provides additional protection to a UAV.

Although the invention has been explained in relation to its preferred embodiment, it is to be understood that many other possible modifications and variations can be made without departing from the spirit and scope of the invention as hereinafter claimed.

What is claimed is:

1. A quick-deploying portable unmanned aerial system/unmanned aerial vehicle landing pad comprises:
a flexible basal platform;
a flexible band;
the flexible band being concentrically aligned with a central axis of the flexible basal platform;
the flexible band being perimetrically and laterally positioned about the flexible basal platform; and
the flexible band being tensionably mounted to the flexible basal platform.

2. The quick-deploying portable unmanned aerial system/unmanned aerial vehicle landing pad as claimed in claim 1 comprises:
an operations management hub;
a plurality of electronic accessories;
the plurality of electronic accessories being operatively integrated into the flexible basal platform; and
the operations management hub being electrically and electronically connected to the plurality of electronic accessories.

3. The quick-deploying portable unmanned aerial system/unmanned aerial vehicle landing pad as claimed in claim 2 comprises:
the operations management hub comprises a rechargeable battery, a housing body, and a microcontroller;
the housing body being laterally tethered to the flexible basal platform;
the rechargeable battery and the microcontroller being mounted within the housing body;
the rechargeable battery being electrically connected to each of the plurality of electronic accessories and the microcontroller; and
the microcontroller being electronically connected to each of the plurality of electronic accessories.

4. The quick-deploying portable unmanned aerial system/unmanned aerial vehicle landing pad as claimed in claim 1 comprises:
a plurality of electronic accessories;
the plurality of electronic accessories comprises a plurality of light-emitting diodes (LEDs);
the plurality of LEDs being distributed about the flexible basal platform; and
each of the plurality of LEDs being integrated into the flexible basal platform, adjacent to a top surface of the flexible basal platform.

5. The quick-deploying portable unmanned aerial system/unmanned aerial vehicle landing pad as claimed in claim 4 comprises:
the plurality of LEDs comprises a set of radial LED strips; and
the set of radial LED strips being radially distributed about the central axis of the flexible basal platform.

6. The quick-deploying portable unmanned aerial system/unmanned aerial vehicle landing pad as claimed in claim 4 comprises:
the plurality of LEDs comprises a set of LED rings;
each within the set of LED rings being concentrically positioned with each other; and
the set of LED rings being radially distributed from the central axis of the flexible basal platform.

7. The quick-deploying portable unmanned aerial system/unmanned aerial vehicle landing pad as claimed in claim 1 comprises:
a plurality of electronic accessories;
the plurality of electronic accessories comprises a wireless communication device and a beacon antenna;
the wireless communication device externally mounted to the flexible basal platform;
the beacon antenna being centrally integrated into the flexible basal platform; and
the wireless communication device being electronically connected to the beacon antenna.

8. The quick-deploying portable unmanned aerial system/unmanned aerial vehicle landing pad as claimed in claim 1 comprises:
a plurality of electronic accessories;
the plurality of electronic accessories comprises an at least one infra-red heating ring;
the infra-red heating ring being concentrically aligned with the central axis the flexible basal platform; and
the infra-red heating ring being integrated into the flexible basal platform.

9. The quick-deploying portable unmanned aerial system/unmanned aerial vehicle landing pad as claimed in claim 1 comprises:
a plurality of high-visibility strips;
the plurality of high-visibility strips being radially distributed about central axis of the flexible basal platform; and
each of the plurality of high-visibility strips being adjacently connected to the top surface.

10. The quick-deploying portable unmanned aerial system/unmanned aerial vehicle landing pad as claimed in claim 1 comprises:
an at least one weight bag;
the weight bag comprises a weighted holding pouch, an at least one pair of straps, and an at least one fastening mechanism;
the pair of straps being laterally connected to the weighted holding pouch;
the weighted holding pouch being laterally positioned to the flexible basal platform;
a first strap from the pair of straps being positioned adjacent to a top surface of the flexible basal platform;
a second strap from the pair of straps being positioned adjacent to a bottom surface of the flexible basal platform;
the fastening mechanism being mechanically integrated into the first strap and the second strap; and
the first strap and the second strap being attached to each other by the fastening mechanism.

11. The quick-deploying portable unmanned aerial system/unmanned aerial vehicle landing pad as claimed in claim 10 comprises:
the fastening mechanism comprises a first magnetic element and a second magnetic element;
the first magnetic element being integrated into the first strap;
the second magnetic element being integrated into the second strap; and
the first magnetic element being coupled to the second magnetic element through the flexible basal platform.

12. A quick-deploying portable unmanned aerial system/unmanned aerial vehicle landing pad comprises:
a flexible basal platform;
a flexible band;
an operations management hub;
a plurality of electronic accessories;
the plurality of electronic accessories comprises a plurality of light-emitting diodes (LEDs) and a wireless communication device;
the wireless communication device externally mounted to the flexible basal platform;
the plurality of LEDs being distributed about the flexible basal platform;
each of the plurality of LEDs being integrated into the flexible basal platform, adjacent to a top surface of the flexible basal platform;
the flexible band being concentrically aligned with a central axis of the flexible basal platform;
the flexible band being perimetrically and laterally positioned about the flexible basal platform;
the flexible band being tensionably mounted to the flexible basal platform;
the plurality of electronic accessories being operatively integrated into the flexible basal platform; and
the operations management hub being electrically and electronically connected to each of the plurality of electronic accessories.

13. The quick-deploying portable unmanned aerial system/unmanned aerial vehicle landing pad as claimed in claim 12 comprises:
the operations management hub comprises a rechargeable battery, a housing body, and a microcontroller;
the housing body being laterally tethered to the flexible basal platform;
the rechargeable battery and the microcontroller being mounted within the housing body;
the rechargeable battery being electrically connected to each of the plurality of electronic accessories and the microcontroller; and
the microcontroller being electronically connected to each of the plurality of electronic accessories.

14. The quick-deploying portable unmanned aerial system/unmanned aerial vehicle landing pad as claimed in claim 12 comprises:
the plurality of LEDs comprises a set of radial LED strips; and
the set of radial LED strips being radially distributed about the central axis.

15. The quick-deploying portable unmanned aerial system/unmanned aerial vehicle landing pad as claimed in claim 12 comprises:
the plurality of LEDs comprises a set of LED rings;
each within the set of LED rings being concentrically positioned with each other; and
the set of LED rings being radially distributed from the central axis.

16. The quick-deploying portable unmanned aerial system/unmanned aerial vehicle landing pad as claimed in claim 12 comprises:
the plurality of electronic accessories comprises a beacon antenna; and
the beacon antenna being centrally integrated into the flexible basal platform.

17. The quick-deploying portable unmanned aerial system/unmanned aerial vehicle landing pad as claimed in claim 12 comprises:
the plurality of electronic accessories comprises an at least one infra-red heating ring;
the infra-red heating ring being concentrically aligned with the central axis the flexible basal platform; and
the infra-red heating ring being integrated into the flexible basal platform.

18. The quick-deploying portable unmanned aerial system/unmanned aerial vehicle landing pad as claimed in claim 12 comprises:
a plurality of high-visibility strips;
the plurality of high-visibility strips being radially distributed about central axis; and
each of the plurality of high-visibility strips being adjacently connected to the top surface.

19. The quick-deploying portable unmanned aerial system/unmanned aerial vehicle landing pad as claimed in claim 12 comprises:
an at least one weight bag;
the weight bag comprises a holding pouch, an at least one pair of straps, and an at least one fastening mechanism;
the pair of straps being laterally connected to the holding pouch;
the holding pouch being laterally positioned to the flexible basal platform;
a first strap from the pair of straps being positioned adjacent to the top surface of the flexible basal platform;
a second strap from the pair of straps being positioned adjacent to a bottom surface of the flexible basal platform;
the fastening mechanism being mechanically integrated into the first strap and the second strap; and
the first strap and the second strap being attached to each other by the fastening mechanism.

20. The quick-deploying portable unmanned aerial system/unmanned aerial vehicle landing pad as claimed in claim 19 comprises:
the fastening mechanism comprises a first magnetic element and a second magnetic element;
the first magnetic element being integrated into the first strap;
the second magnetic element being integrated into the second strap; and
the first magnetic element being coupled to the second magnetic element through the flexible basal platform.
